(19) United States
(12) Patent Application Publication
(10) Pub. No.: US 2008/0060000 A1
(43) Pub. Date: Mar. 6, 2008

(54) PERSONALIZED ADVERTISING IN MOBILE TELEVISION

(76) Inventors: Francois-Xavier Drouet, La Gaude (FR); Fabien Lanne, Valbonne (FR); Gerard Marmigere, Drap (FR)

Correspondence Address: HOFFMAN, WARNICK & D'ALESSANDRO LLC, 75 STATE ST, 14 FL, ALBANY, NY, 12207, US

(21) Appl. No.: 11/843,819

(22) Filed: Aug. 23, 2007

(30) Foreign Application Priority Data
Aug. 31, 2006 (EP) 06300903.9

(51) Int. Cl. H04N 7/16

(52) U.S. Cl. 725/34

(57) ABSTRACT

The present invention is directed to a method and apparatus for personalized advertising in mobile broadcast television. A method for use in a personal device, for personalizing a service broadcast over a digital broadcast, in accordance with an embodiment of the invention, includes: receiving content for personalizing and display on the personal device, comparing the content with a user profile stored on the personal device to generate a stored personalized content for storage on the personal device, receiving a broadcast service for display on the personal device, and stopping the display at a predetermined time and displaying instead the stored personalized content.

### FIELD OF THE INVENTION

The present invention relates to a method and apparatus for personalized advertising in mobile broadcast television.

### BACKGROUND OF THE INVENTION

Mobile television is a television service provided on a mobile phone or other personal devices. A mobile TV is intended primarily for individuals to watch programs on a small screen TV when traveling or in other public spaces.

The television programs are provided to the mobile device generally by a digital video broadcasting standard. An example of such a digital video broadcasting standard is digital video broadcasting handheld (DVB-H). DVB-H is a technical specification for bringing broadcast services to handheld receivers by adapting DVB-T. Time slicing technology is employed to reduce power consumption for small handheld terminals and data is transmitted in bursts at specific timeslots. A number of channels may be transmitted in each or in a sequence of specific timeslots. The data that the timeslots carry may be defined by the broadcaster and include a sequence of videos, music, advertisements, and any other kind of data.

### SUMMARY OF THE INVENTION

The present invention is directed to a method and apparatus for personalized advertising in mobile broadcast television.

The present invention provides a method of providing personalized advertisements on a DVB-H receiver, and provides a different way of operating a DVB-H type television service on a mobile device. Further, the present invention makes better use of the storage capabilities available on the mobile device in order to provide better services for the users and broadcasters alike.

In a first aspect, the present invention discloses a method for use in a personal device, for personalizing a service broadcast over a digital broadcast, comprising: receiving content for personalizing and display on the personal device, comparing the content with a user profile stored on the personal device to generate a stored personalized content for storage on the personal device, receiving a broadcast service for display on the personal device, stopping the display at a predetermined time and displaying instead the stored personalized content.

According to another aspect of the present invention there is provided a method of personalizing a service broadcast over a digital broadcast to a personal device, comprising: sending content for personalizing and display on the personal device which content is compared with a user profile stored on the personal device to generate a stored personalized content for storage on the personal device; broadcasting a service to the personal device for display on the personal device which service may be interrupted at a predetermined time to display the stored personalized content.

According to another aspect of the present invention there is provided a method of operating a digital video broadcast service for broadcasting a service to a plurality of personal devices each having a memory in which is stored a user profile comprising: selling space on the memory of the personal device for third parties to store information for display to a user; comparing the information with the user profile; storing information, for each user, which matches at least one criteria related to the user profile; at a first predetermined point in a broadcast displaying the stored information rather than the service; at a second predetermined point stopping displaying the stored information and returning to the service

In accordance with the present invention, advertising can be personalized for a specific user of a specific mobile device. The sequence of personalized advertising can be determined for different times of the day and for different environments in which the users find themselves. In addition, by providing an additional memory facility, advertisement of a certain nature may be pre-recorded thereon and used at anytime by the user. For example, an advertisement from a telephone provider advertising new services may be downloaded and stored on a high density SIM card based on a user profile in order that personalized advertisements can be presented to the user. The user profile which is resident on the mobile equipment influences advertising and presentation of other information beyond advertising to the user concerned.

### BRIEF DESCRIPTION OF THE DRAWINGS

These and other features will be more readily understood from the following detailed description taken in conjunction with the accompanying drawings.

FIG. 1 is a block diagram showing a typical mobile television environment.

FIG. 2 is a diagram showing advertising clips that are downloaded and user selections of those advertising clips at a time when advertising is to be shown.

FIG. 3 is a table showing the client advertising information for a specific user.

FIG. 4A is a diagram of the broadcasting of information to a user and a subsequent user specific advertising that is sequenced in accordance with the user profile at a first time.

FIG. 4B is a diagram of the broadcasting of information to a user and a subsequent user specific advertising that is sequenced in accordance with the user profile at a second time.

FIG. 5 is a block diagram depicting an illustrative client architecture.

FIG. 6 is a flow chart showing an illustrative method of using a specific user profile determine advertising clips.

### DETAILED DESCRIPTION OF THE INVENTION

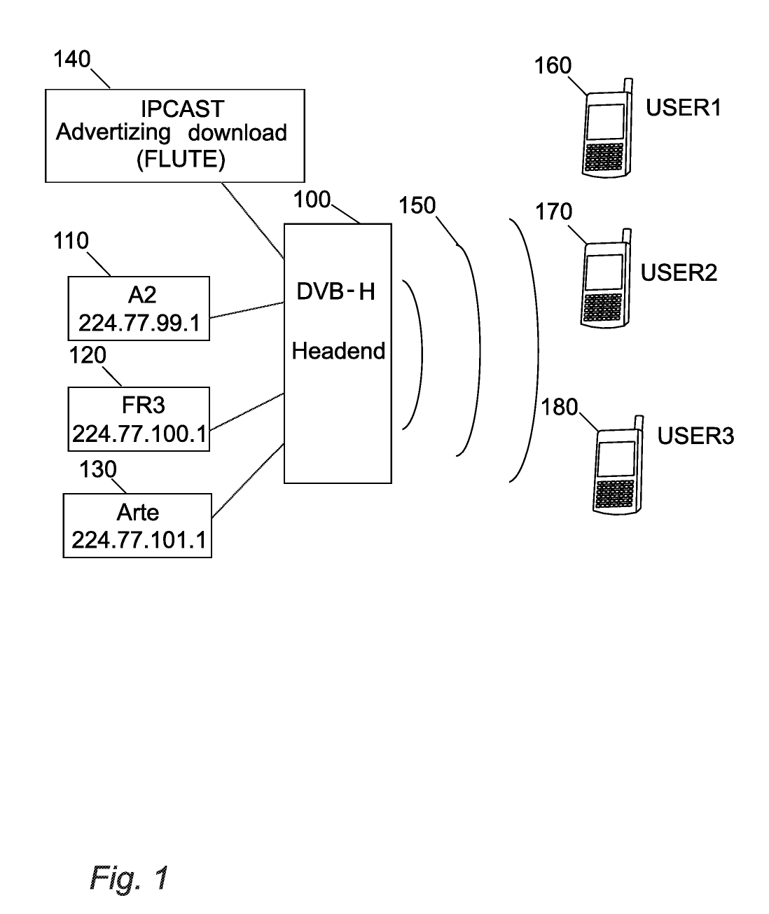

Referring now to FIG. 1, there is illustrated a DVB-H head end 100 that is broadcasting, for example, three television channels A2 110, FR3 120 and Arte 130. Each of these broadcasts is being delivered over a specific IPcast timeslot in common with the standard practices for the DVB-H transmission standard. In addition, an IPcast advertising download is delivered over a FLUTE protocol which is broadcast over an appropriate timeslot. The three television channels and the advertising download are broadcast 150 to user 1 160, user 2 170 and user 3 180.

The IPcast of advertising downloaded using the FLUTE protocol comprises a plurality of advertising objects having a duration that is a multiple of a unit duration defined for the overall system. Several advertising objects may be joined together to form a particular advertisement sequence having the same duration as the advertising sequence programmed on the video channel to enable scheduling in accordance with the present invention.

Each user has a mobile device including a dedicated SIM card. The SIM card will be described in greater detail below and has the capacity to store information. One of the pieces of information that the SIM card stores is details on the user including profile information. This profile information may include personal data; for example, name, age, sex, address, subscription, preferences and any other information that may be relevant to determine a personal profile of the user. The list of information identified above is not in any way restrictive and could include any other element of information that is deemed to be used. The data forming the profile information may be downloaded at the time of subscription by the service provider, may be entered by the user, or may be downloaded through a broadcast or telephone transmission. There is no limit to the way in which the information may be stored in the first instance or updated at a later date.

The mobile device may be a PDA, a telephone, a computer, or any other personal or portable device.

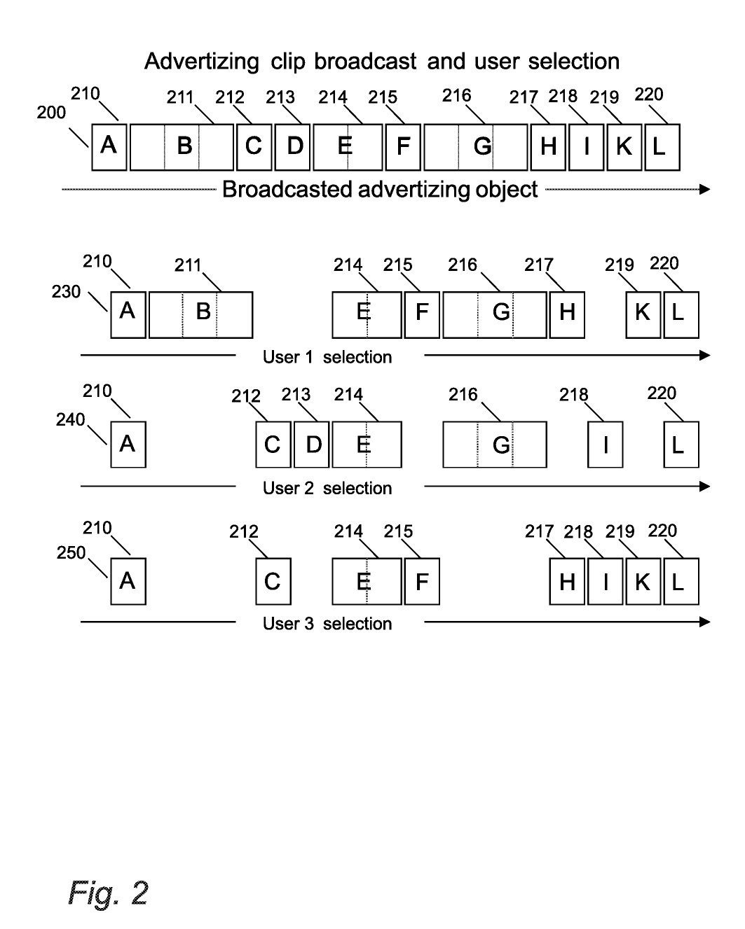

Referring now to FIG. 2, a broadcast advertising selection 200 is shown. The broadcast advertising selection includes a plurality of advertisements A 210, B 211, C 212, D 213, E 214, F 215, G 216, H 216, I 218, K 219 and L 220, which are transmitted periodically through the datacast channel using the FLUTE protocol. Advertisement B is a three unit duration advertisement, advertisement E comprises two units, and advertisement F, for example, comprises one unit. On receipt of the advertising broadcast selection of advertisements, the user will select specific ones of the advertisements to be stored. This selection will depend on the user profile and will select advertisements that are most appropriate to that user. This may be based for example on age, sex, or geographic location. Since the mobile device is mobile, the location of the mobile device may be identified and this may also assist in determining the user advertisement available for a specific user. For example, if a user is in a specific town, the advertisement may relate to services and companies in that town.

From FIG. 2, it can be seen that the user 1 selection includes advertisements A, B, E, F, G, H, K and L, the user 2 selection includes advertisements A, C, D, E, G, I, L, and the user 3 selection includes advertisements A, C, E, F, H, I, K and L.

In an example, advertisement B may be for a specific cosmetic and user 1 may be a female. User 1 may be interested in viewing advertisement B, whereas users 2 and 3 are both men and may not be so interested. Similarly, user 2 may be found in Nice, France, and advertisement D is for a pizza restaurant in Nice, the location of user 2 being an automatic profile selection for a localized personalized advertisement.

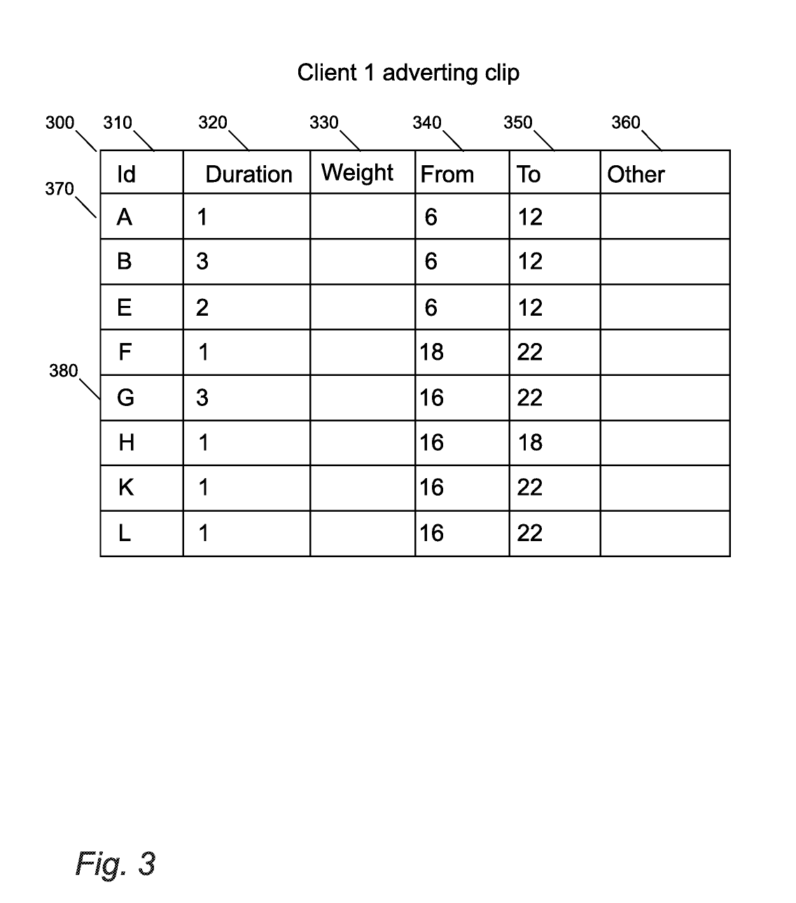

Referring now to FIG. 3, a table 300 stored, for example, on the SIM card in the mobile device of user 1 is shown. The table 300 includes advertisement identification 310, the duration of the advertisement 320, a weighting factor 330, an applicable starting period 340, an applicable finishing period 350, and a column for other information 360. The identification code in the advertisement identification 310 corresponds to the advertisement shown in FIG. 2. The duration indicates the number of time periods that advertisement lasts and again corresponds with FIG. 2. The weighting factor 330 may be a feature derived from the user profile which indicates the nature of a particular advertisement is one that the user weights highly. Alternatively the weighting could suggest other factors that influence the selection and choice based on the user profile. The starting period 340 indicates the time from which the advertisement should be played. This may be user defined or advertiser defined. The finishing period 350 suggests the time until which such advertising should be presented. The other information 360 may include other information relevant to the advertisement, the user, user profile, and/or the like.

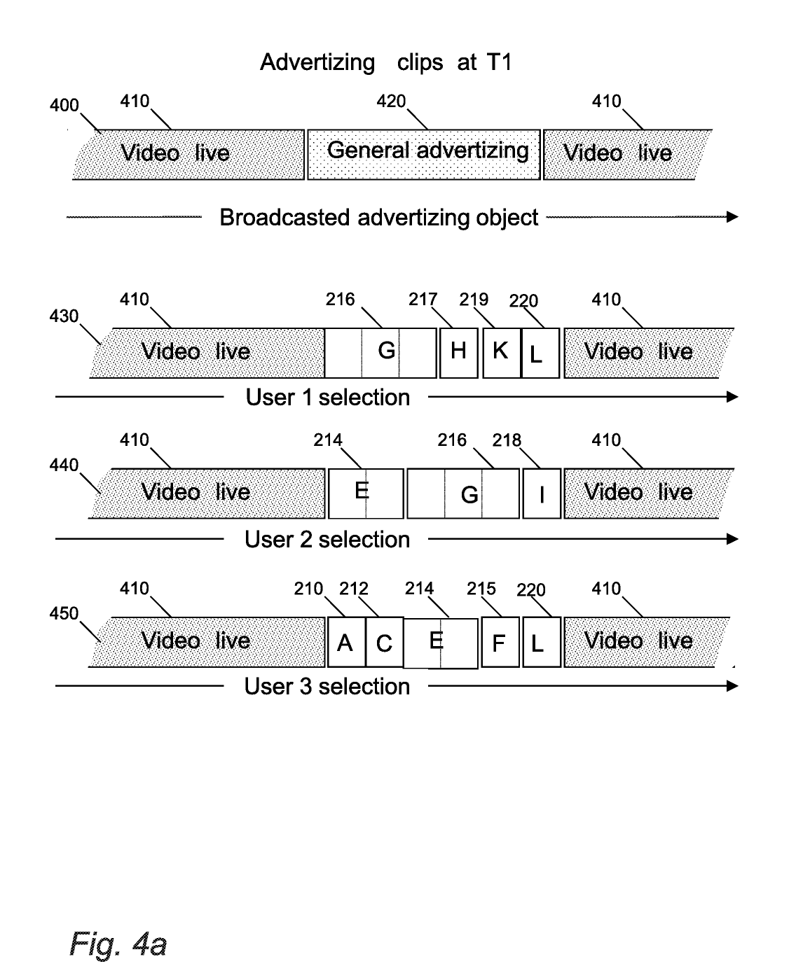

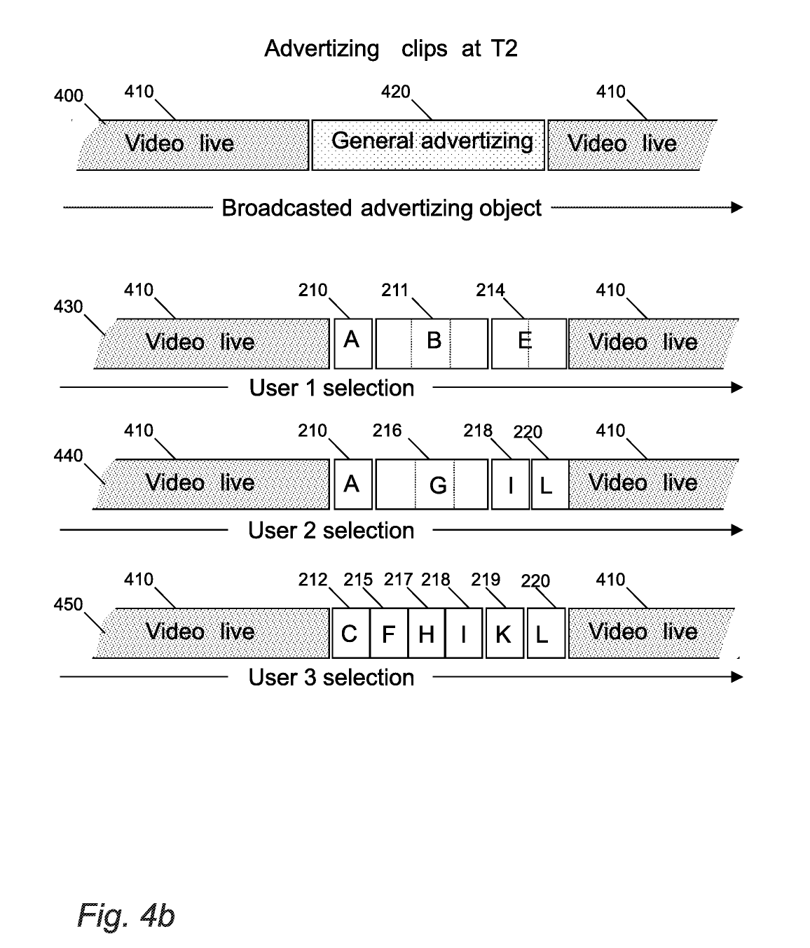

FIG. 4A shows the treatment of a broadcast including advertising at a time T1. A DVB-H broadcast 400 is broadcast. It includes video live 410, general advertising 420, and video live 410 again. The general advertising 420 is provided by the broadcaster and is transmitted in a normal way over a particular channel in question by the DVB-H standard. References 430, 440 and 450 show the information viewed by users 1, 2, and 3, respectively. Each user sees the video live 410. However at the point when the video stops and the general advertising would normally start, because user 1 has personalized advertising, an alternative process takes place. In this alternative process, the general advertising 420 is replaced with user selected advertising based on the profile of user 1. Accordingly, user 1 views instead of the general advertising 420, advertisement G 216, H 217, K 219, and L 220. After the advertisement slot, whether it be general or personalized, each user then will continue to view the video live 410. The length of time the general advertising is going to continue will be indicated at the start of the advertising slot. From this indication, the number of required personalized advertisements to fill that slot can be calculated and determined. It should be noted that the general advertising is similarly made up of blocks of advertising of the same length as the blocks in the user defined advertising.

The user 2 selection of personalized advertisement is different from that of user 1. User 2 views advertisements E 214, G 216, and I 218 before returning to the video live 410. Similarly, user 3 views yet another set of advertisements A 210, C 212, E 214, F 215, and L 220. To this extent, as can be seen in FIG. 4A, the advertisements displayed to each user are completely different from one to the next. However, the time delay between the commencement of the advertisement and the end of the advertisement is the same due to the fact that the combined advertisements have a predetermined duration (i.e., the length of the general advertising 420).

FIG. 4B shows the same scenario at a time T2. It can be seen at this time that each user has a different selection of advertisement presented to them. This is again as previously indicated based on the user profile of the user and the available advertisement stored locally on the user's device.

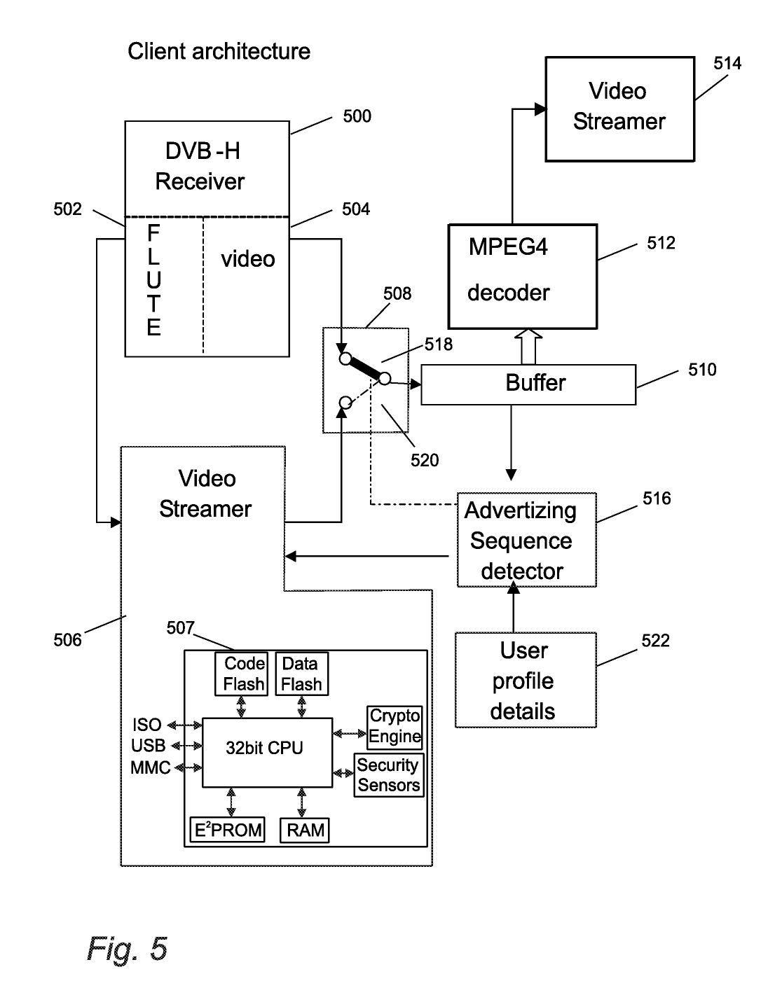

Referring now to FIG. 5, an illustrative client architecture for carrying out the functionality described above in accordance with an embodiment of the present invention will now be described in detail. A DVB-H receiver 500 receives an incoming DVB-H broadcast. This may include files and data that form part of the FLUTE standard or video. The data and files forming part of the FLUTE standards are received in the FLUTE element 502 and the video is received in the video element 504. The FLUTE data may be used for a number of different purposes. However, for the purposes of this invention, the only detail described will be how advertisements are handled and stored. The advertisements received in the FLUTE receiver 502 are stored in a high density SIM card or any other memory card 507. The memory may be found associated with a video streamer 506 or in another location. The video is passed by a switch 508 to a buffer 510 (when the switch is in position 518). The video after having been buffered will be sent through an MPEG4 decoder 512 to a video streamer 514. The video is then displayed to the user.

The buffer 510 is also connected to an advertising sequence detector 516, which in turn is connected to the advertising video streamer 506. The advertising sequencing detector 516 has the ability to change the switch from position 518 to 520. This allows the video streamer 506 for advertisements to load the buffer 510 instead of the standard video. The advertising sequence detector 516 also has access to the user profile details 522. As previously indicated the user profile details may be stored on a SIM or at any other memory location in the user device.

In the stream of video that is output by the video streamer 514 as has previously been indicated, there is a section of programming followed by advertisement and then return to the program. Just before, or at the point of arrival of the advertisement, at the buffer 510 an indicator is detected by the advertising sequence detector 516. If there is any indication that user profile details 522 and personalized advertising is available for the user in question, the advertising sequence detector 516 will switch the switch 508 to position 520. If there is no such user profile details 522 or personalized advertising scheme, the advertising sequence detector 516 will allow the switch 508 to remain in position 518 and the user will view the general advertising included in the video stream.

In the former case where the advertising sequence detector 516 identifies user profile details 522 of customized advertising and the switch 508 is switched to 520, the advertising sequence detector 516 will interpret the user profile details 522. This interpretation will lead to the video streaming of personalized advertisement from the video streamer 506 through to the buffer 510 in accordance with the user profile details 522 as previously described.

At the end of the advertising sequence, just before the video is to recommence, another indicator is detected by the advertising sequence detector 516 which facilitates switching back of the switch 508 from position 520 to 518. The user then see the video, film, or other program they were watching. The advertising sequence detector 516 will use user profile tables, the advertising streamer 506, and an advertising scheduler, which may be based on the indicators mentioned above or may be in any other forms. The advertisement schedule may be something that is downloaded at the start of a video sequence and stored in the advertising sequence detector 516. A time signal may be used to enable the advertising sequence detector 516 to change over to personalize advertising at the required time. The manner in which advertising sequence detector 516 utilizes the user profile details 522 or the other information available will depend on the circumstances and may vary in detail from one situation to the next. However, the principal is common that the general advertising on the video stream is replaced with personalized advertising.

The user profile details 522 are stored in a table within the advertising sequence detector 516. This table may be generated from data stored elsewhere in the user device. As previously indicated, one such place where the user profile details 522 will be stored is in a SIM card 507.

Recently, high capacity SIM cards have been proposed which will include flash memory of up to 256 megabytes. In accordance with the present invention, it is proposed that the user profile details 522 be stored on this flash memory but also that the advertisements associated with personalized advertising could also be stored on the flash memory. The advertisements may be stored at the outset of the inscription of the user to a service or may be downloaded and stored on the flash after the user has commenced using his device (software downloads being common in mobile device technology these days).

The new high capacity SIMs mentioned above are relatively expensive and it is expected that telephone operators whilst wishing to use them will avoid using them due to cost impact. However, in accordance with this invention, there exists a different business model with which to introduce and adopt the high capacity SIM cards now available. This can be achieved by using the memory to store advertisement and then charging the advertisers for the storage space. The result of this will be that the effective cost of the SIM card to the user and all the operators will be reduced as some of the costs therefore will be paid by the advertising revenue. Making use of the user profile, the operator may sell advertising space on the SIM card to advertisers for display to particular types of users.

The business model associated with this could envisage a number of different scenarios. In one scenario, the advertiser could have advertisement stored on the flash card from the start of the inscription of the user. In an alternative environment the advertiser could store advertisements at the start of the inscription and later download replacement or additional advertisement(s) that change in accordance with one or more parameters including time, user profile, etc. In an alternative scenario, the advertiser could rent advertising space on flash cards and download by a software download advertising that is appropriate at that particular moment, location or for any other reason.

The advertiser could be charged for the advertising space based on any appropriate mechanism. For example, based on the number of users who view the content, on the amount of memory space rented or any other mechanism.

In addition, the SIM card may have other areas which can be rented by other users for storing information of other advertisements. For example, part of the flash memory may be rented by a telephone provider to include a part of a telephone directory that is relevant to the particular user. The idea of selling advertising space on a user memory element forms the basis of an alternative embodiment of the present invention.

It will be appreciated that not only the flash memory of a SIM card could be made available to advertisers and other people wishing to hire advertising space, but also any other relevant memory areas of the user device. The manufacturer or service provider that provides the user device to the user will be responsible for the advertising or other download space that is available to advertisers and other users. For example, trial games may be downloaded in order to persuade people to buy the real version of the game. A section of the memory may be made available to personalize advertising based on a location of the user. Space for localized information may be available for example hotels, restaurants, cinemas, other attractions etc, based on the location of the user. This space may be rented to different advertisers or information providers when the user is in different locations. In each situation, the material may be downloaded by software download or any other appropriate means. By selling space on the memory of a user device, many different applications can be carried out. The result to the service provider and the user being that the effective cost of the device and some of the services may be reduced. The business model of changing the emphasis of where the revenue streamed arrives for expensive equipment such as the new generation SIM cards thereby forms an embodiment of the present invention.

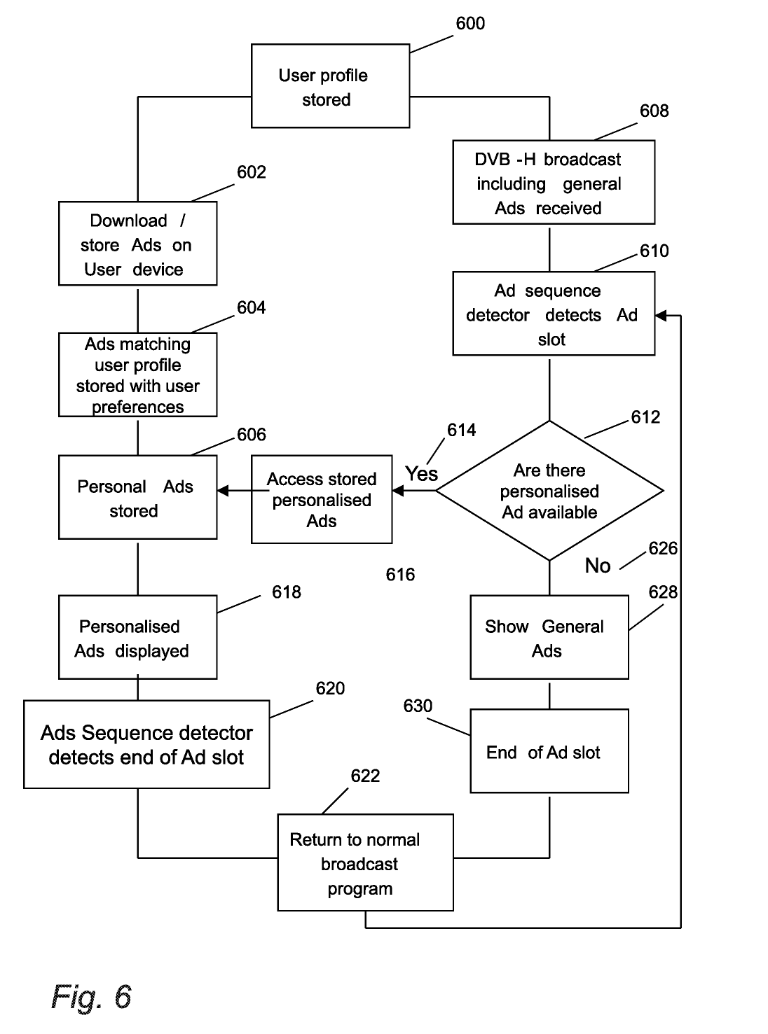

Referring now to FIG. 6, a flow chart of an illustrative method of personalized advertising in accordance with an embodiment of the present invention is now shown.

At a certain point in time the user profile is stored (600). After this, advertisements which can be personalized are downloaded or stored on the user device in some appropriate memory location (602). As previously indicated, this memory location may form part of a SIM card or any other appropriate memory on the user device. Any stored or downloaded advertisements are then compared with the user profile and matches with the user profile are identified with those user preferences (604). The advertisements that match the user profile or the user preferences will then be stored as personalized advertisements (606).

In the meantime, a user decides to watch a DVB-H broadcast which includes some general advertisements (608). At a predetermined time, if scheduling is used, or in response to an indicator, the advertisement sequence detector 516 (FIG. 5) detects that an advertisement slot is coming up (610). A determination is then made as to whether personalized advertisements are available or not (612). If there are stored personalized advertisements (Yes, 614) the personalized advertisements are accessed (616). This means that the stored personalized advertisements are then displayed to the user in accordance with the user profile table scheduling or any other parameters that dictate the nature of display at that time (618). The parameters that might control this may be time, location, personal preferences, etc.

At a further time, the advertising sequence detector 516 detects the end of the advertisement slot (620). At this point, the personal advertisements are stopped and the broadcast is returned to the normal program (622). The user may then continue to watch the program until the next sequence of advertisements is detected at 610. Alternatively the user may stop watching the broadcast at any time either before, during, or after the advertisements at which point the whole process will stop.

At 612, if there are no personalized advertisements available (No, 612), then general advertisements are shown or included in the original DVB broadcast (628). At the end of the advertising slot (630), the normal programming is resumed (622) and the device waits again for the arrival of a detection of a new advertisement slot (610).

The present invention has been described with particular reference to providing personalized advertisement. However it will be appreciated that the same process could be used to personalize other elements for example personalized programming in the DVB-H environment if there is sufficient memory to store personalized broadcasts. Different information from advertisement may also be downloaded and stored in accordance with the present invention.

In addition, the business model of selling advertising or other space on user memory devices could take on a variety of different orientations and options.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

As used herein, the term “computer program code” refers to any expression, in any language, code or notation, of a set of instructions intended to cause a computer system having an information processing capability to perform a particular function either directly or after either or both of the following: (a) conversion to another language, code or notation; and (b) reproduction in a different material form. The computer program code can be embodied as one or more types of computer program products, such as an application/software program, component software/library of functions, an operating system, a basic I/O system/driver for a particular computing and/or I/O device, and the like.

It should be appreciated that the teachings of the present invention could be offered as a business method on a subscription or fee basis. For example, a service provider (e.g., a provider of cell phone service) can create, maintain, enable, and deploy a text-to-speech assist for portable communication devices, as described above.

The foregoing description of the preferred embodiments of this invention has been presented for purposes of illustration and description. It is not intended to be exhaustive or to limit the invention to the precise form disclosed, and obviously, many modifications and variations are possible.

1. A method for use in a personal device, for personalizing a service broadcast over a digital broadcast, comprising:
receiving content for personalizing and display on the personal device;
comparing the content with a user profile stored on the personal device to generate a stored personalized content for storage on the personal device;
receiving a broadcast service for display on the personal device; and
stopping the display at a predetermined time and displaying instead the stored personalized content.

2. The method of claim 1, further comprising:
storing a user profile on the personal device.

3. The method of claim 1, further comprising:
updating the user profile.

4. The method of claim 1, further comprising:
receiving updated content for the user for personalizing and display on the personal device.

5. The method of claim 1, further comprising:
receiving the content as advertisements which can be personalized to form personalized advertisements.

6. The method of claim 5, further comprising:
stopping the display of the broadcast at an advertising slot containing general advertising and replacing the general advertising with the personalized advertisements.

7. The method of claim 1, further comprising:
at a second predetermined time stopping display of the personalized content and returning to the broadcast display.

8. The method of claim 1, further comprising:
receiving the content over a FLUTE transmission.

9. The method of claim 1, further comprising:
receiving the broadcast using a DVB-H standard.

10. A method of personalizing a service broadcast over a digital broadcast to a personal device, comprising:
sending content for personalizing and display on the personal device;
comparing the content with a user profile stored on the personal device to generate a stored personalized content for storage on the personal device;
broadcasting a service to the personal device for display on the personal device; and
interrupting the service at a predetermined time to display the stored personalized content.

11. A system for personalizing a service broadcast over a digital broadcast, comprising:
a system for receiving content for personalizing and display on a personal device;
a system for comparing the content with a user profile stored on the personal device to generate a stored personalized content for storage on the personal device;
a system for receiving a broadcast service for display on the personal device; and
a system for stopping the display at a predetermined time and for displaying instead the stored personalized content.

12. The system of claim 11, further comprising:
a system for storing a user profile on the personal device.

13. The system of claim 11, further comprising:
a system for updating the user profile.

14. The system of claim 11, further comprising:
a system for receiving updated content for the user for personalizing and display on the personal device.

15. The system of claim 11, further comprising:
a system for receiving the content as advertisements which can be personalized to form personalized advertisements.

16. The system of claim 15, further comprising:
a system for stopping the display of the broadcast at an advertising slot containing general advertising and for replacing the general advertising with the personalized advertisements.

17. The system of claim 11, further comprising:
a system for stopping display of the personalized content at a second predetermined time and for returning to the broadcast display.

18. The system of claim 11, further comprising:
a system for receiving the content over a FLUTE transmission.

19. The system of claim 11, further comprising:
a system for receiving the broadcast using a DVB-H standard.

20. A program product stored on a computer readable medium, which when executed, personalizes a service broadcast over a digital broadcast, the computer readable medium comprising program code for:
receiving content for personalizing and display on the personal device;
comparing the content with a user profile stored on the personal device to generate a stored personalized content for storage on the personal device;
receiving a broadcast service for display on the personal device; and
stopping the display at a predetermined time and displaying instead the stored personalized content.

21. A method of operating a digital video broadcast service for broadcasting a service to a personal device having a memory in which is stored a user profile, comprising:
selling space on the memory of the personal device for third parties to store information for display to a user;
comparing the information with the user profile;
storing information which matches at least one criteria related to the user profile;
at a first predetermined point in a broadcast displaying the stored information rather than the service; and
at a second predetermined point stopping displaying the stored information and returning to the service.

22. The method of claim 21, further comprising:
charging the third party in accordance with a number of times the stored information is displayed to a user.

23. The method of claim 21, further comprising:
charging the third party in accordance with an amount of space taken up by the stored information in the memory.

24. The method of claim 21, further comprising:
storing the user profile and the stored information on a memory card.
